(19) United States
(12) Patent Application Publication
(10) Pub. No.: US 2007/0159108 A1
(43) Pub. Date: Jul. 12, 2007

(54) Flat panel display and display device

(76) Inventors: Shin'ya Fukuta, Kobe (JP); Yoshiho Seo, Akashi-shi (JP); Keiichi Betsui, Yokohama-shi (JP)

Correspondence Address: STAAS & HALSEY LLP, SUITE 700, 1201 NEW YORK AVENUE, N.W., WASHINGTON, DC, 20005, US

(21) Appl. No.: 11/598,682

(22) Filed: Nov. 14, 2006

(30) Foreign Application Priority Data
Jan. 10, 2006 (JP) 2006-002967

(51) Int. Cl. G09G 3/10; H01J 17/49

(52) U.S. Cl. 315/169.4; 315/169.2; 313/582

(57) ABSTRACT

A flat panel display includes a discharge space filled with discharge gas and a plurality of electrodes for generating discharge in the discharge space. Ferroelectric powder is disposed between the electrodes and the discharge space so that the ferroelectric powder contacts the discharge space.

### BACKGROUND OF THE INVENTION

1. Field of the Invention

The present invention relates to a flat panel display such as a plasma display panel (PDP) or a plasma address liquid crystal (PALC) for displaying images by gas discharge and a display device having this type of flat panel display.

2. Description of the Prior Art

A display device having an AC type plasma display panel performs a data write operation called addressing for setting on and off of cells that constitute a screen and a display operation called sustaining after the addressing. In addition, prior to the addressing, a so-called initializing operation is performed usually. Purposes of the initializing operation are to equalize a charge storage state of cells and to generate priming particles that facilitate generation of discharge in the addressing (address discharge).

However, the priming particles decrease as time passes from the initializing operation, and thus a discharge delay increases. The discharge delay is generally considered as a sum of a statistical delay and a formation delay. The statistical delay corresponds to a time period from an application of voltage to a start of discharge after starting ionization. The formation delay corresponds to a time period from the start of discharge until steady-state discharge is formed, and it is a minimum value when a discharge start time is measured many times. If the discharge delay is long, discharge may not be generated during a time corresponding to a pulse width resulting in increase of display errors. For this reason, it is necessary to increase the pulse width for increasing discharge probability. Then, time assigned to the addressing increases resulting in decrease of time that can be assigned to the display operation. Therefore, it is desirable that the discharge delay is short in driving the plasma display panel.

Japanese unexamined patent publication No. 2002-110051 describes about shortening of the discharge delay. This document discloses a method of shortening the discharge delay by providing a long persistence afterglow substance (afterglow time is 0.1 ms or more) that emits ultraviolet light or visible light in an inner area that is irradiated with vacuum ultraviolet light generated by the gas discharge and by increasing a time period during which the priming particles are generated. In this method, probability that the discharge gas is ionized by the ultraviolet light emitted from the long persistence afterglow substance is very small (substantially zero). Therefore, it is necessary to add a low work function substance at the same time.

In addition, there is another document describing about shortening the discharge delay, which is Japanese unexamined patent publication No. 2000-200553. This document discloses a plasma display panel having a ferroelectric layer. A ferroelectric has a permanent dipole generated by spontaneous polarization, and it generates a polarization inversion when an electric field is applied. As a result of the polarization inversion, the ferroelectric has hysteresis. When the polarization inversion is generated, electron emission (Roenblum et al., J. Appl. Phys. Lett., 25 (1974) p 17) or plasma light emission (D. Shur et al., Appl. Phys. Lett., 70 (1997) p 574) occurs. This action of the ferroelectric generates the priming particles, which contribute to shortening the discharge delay. Unlike the long persistence afterglow substance described above, electron or ion emission from a ferroelectric has an advantage that an emission timing can be controlled freely by applying voltage. Therefore, a method of disposing the ferroelectric layer is more effective than a method of disposing the long persistence afterglow substance.

However, the method of disposing the ferroelectric layer as disclosed in Japanese unexamined patent publication No. 2000-200553 has problems of manufacturing process and operational characteristics as follows.

(1) Since the ferroelectric is formed in a film forming process, a heat treatment at a few hundred degrees centigrade or higher is inevitable for securing ferroelectricity. The heat treatment may affect other elements constituting the cell.

(2) A variation of membranaceous (crystal orientation) that determines the ferroelectricity is likely to be generated.

(3) Having the ferroelectric as a layer causes an increase of parasitic capacitance resulting in an increase of power consumption.

### SUMMARY OF THE INVENTION

An object of the present invention is to provide a panel structure that can utilize an action of electron emission from a ferroelectric and is manufactured easily.

A flat panel display according to an aspect of the present invention includes a discharge space filled with discharge gas, a plurality of electrodes for generating discharge in the discharge space, and ferroelectric powder that is disposed between the electrodes and the discharge space so that the ferroelectric powder contacts the discharge space. In a manufacturing process of a flat panel display, powder having a predetermined ferroelectricity is disposed. Therefore, a heat treatment for obtaining the ferroelectricity can be omitted. In addition, since a film forming process can also be omitted, the structure of the flat panel display has an advantage in a manufacturing cost. As a method of disposing the powder, there are some methods including a method of mixing the powder in the dielectric protection layer or fluorescent material layers exposed to the discharge space and a method of scattering the powder on the surface exposed to the discharge space.

In addition, as the powder is disposed, the ferroelectric is dotted on the surface exposed to the discharge space. Therefore, increase of parasitic capacitance due to the ferroelectric can be minimized.

A response of the polarization (charge density) to the external electric field intensity of the ferroelectric in the flat panel display can be characterized by the coercive electric field intensity that is electric field intensity at which the polarization is reversed and spontaneous polarization at that time. An important condition for utilizing the ferroelectric is that the coercive electric field intensity is low. A well-known ferroelectric such as barium titanate (BaTiO₃) or lead zirconate titanate (PZT or Pb(Zr, Ti)O₃) has coercive electric field intensity higher than or equal to 100 KV/cm. In the case of a plasma display panel that is a typical flat panel display having a discharge space, a size of the discharge space in the panel thickness direction is approximately 100 μm (=0.01 cm). Therefore, if a ferroelectric having coercive electric field intensity of 100 KV/cm is used, a voltage value to be applied is approximately 1000 V. Since a drive voltage of the plasma display panel has a value of 200-300 V at highest, it is difficult to make the polarization inversion occur. A practical ferroelectric has coercive electric field intensity of 50 kV/cm or lower. A ferroelectric having coercive electric field intensity of 10 kV/cm or lower is preferable. As the ferroelectric that satisfies this condition, there is strontium bismuth tantalate (SBT or SrBi₂Ta₂O₂) that is used in a field of a ferroelectric memory. Its coercive electric field intensity is 50 kV/cm or lower. There is a report in Toyama Industrial Technology Center Report, 15 (2001) IV-80 that a ferroelectric having coercive electric field intensity of 5.7 kV/cm is obtained by mixing manganese (Mg), zinc (Zn), niobium (Nb) or tungsten (W) in PZT.

A practical and typical plasma display panel has a three-electrode structure in which each of cells constituting a screen corresponds to a pair of row electrodes and one column electrode. However, the condition of the driving method according to the present invention can be applied not only to the three-electrode structure but also to a two-electrode structure in which a pair of electrodes are opposed to each other via a discharge space. Here, a cell in the two-electrode structure will be exemplified for describing the condition of the driving method.

FIG. 1 is a schematic diagram of the cell having the two-electrode structure.

In the plasma display panel of FIG. 1, there is a discharge space 2 between a first electrode 3 and a second electrode 4. Each of the first electrode 3 and the second electrode 4 is covered with a dielectric layer 5. Further each of the dielectric layers 5 is covered with an insulator layer 6 containing ferroelectric powder at a mixing ratio within the range from 0.1 ppm to 10% by weight. The surface of the insulator layer 6 is exposed to the discharge space 5, and the ferroelectric powder contained in the insulator layer 6 and located on the surface of the layer contacts the discharge space 5. As a material of the insulator layer 6, a substance having a good spattering-resistant property like magnesia (MgO) is preferable. If the mixing quantity of the ferroelectric powder is excessive, a variation with time due to spattering becomes conspicuous. Therefore, it is preferable that the mixing ratio of the ferroelectric powder is 10% by volume or lower. More preferably, it is within the range from 1% to 1 ppm by volume.

FIG. 2 shows wall voltage transfer characteristics, and FIG. 3 shows P(V) hysteresis characteristics of the ferroelectric.

The wall voltage transfer characteristics mean a relationship between cell voltage when the wall charge is formed and a variation of the wall voltage. From the characteristics, it is possible to know how the wall voltage transfers by an application of what level of the cell voltage. If the cell voltage is low, the variation of the wall voltage is little. If the cell voltage is Vt(+) or higher, or if it is Vt(−) or lower, the wall voltage changes largely. Further, if the cell voltage is high, the variation of the wall voltage becomes a value close to the cell voltage.

If at least one of voltages Vc and −Vc that can generate the polarization inversion in the hysteresis shown in FIG. 3 is included between the voltages Vt(+) and Vt(−), electron emission due to the polarization inversion can be generated. However it is desirable for the driving that the expression Vt(−)<(Vc, −Vc)<Vt(+) is satisfied. It is because stable electron emission can be generated at a low voltage. In order to realize this condition in the plasma display panel having practical conditions of a size, materials and structure, it is necessary to use a ferroelectric having sufficiently low coercive electric field intensity as described above.

Concerning a cell having three or more electrodes, the above description may be expanded in accordance with the number of electrodes. In order to drive a cell having three or more electrodes by a practical method, it is necessary to use a ferroelectric having sufficiently low coercive electric field intensity.

According to the present invention, the discharge delay can be decreased, so that a flat panel display having a good productivity can be provided. In addition, power consumption can be reduced.

### BRIEF DESCRIPTION OF THE DRAWINGS

FIG. 1 is a schematic diagram of a cell having a two-electrode structure.

FIG. 2 is a diagram showing wall voltage transfer characteristics.

FIG. 3 is a diagram showing P(V) hysteresis characteristics of a ferroelectric.

FIG. 4 is a diagram showing a structure of a display device according to one embodiment of the present invention.

FIG. 5 is an exploded perspective view showing a cell structure of a plasma display panel according to one embodiment of the present invention.

FIG. 6 is a diagram showing a Vt closed curve in a cell of a three-electrode structure.

FIG. 7 is a diagram showing a ferroelectric inversional (inverted) curve in the structure including a ferroelectric disposed on the back side of a discharge space.

FIGS. 8A and 8B are diagrams showing a relationship between the Vt closed curve shown in FIG. 6 and the ferroelectric inversional curve shown in FIG. 7.

FIG. 9 is a diagram of drive voltage waveforms showing a general drive sequence of a sub frame.

FIG. 10 is a diagram showing the ferroelectric inversional curve in the structure including a ferroelectric disposed on the front side of the discharge space.

FIG. 11 is a diagram showing a relationship between the Vt closed curve shown in FIG. 6 and the ferroelectric inversional curve shown in FIG. 10.

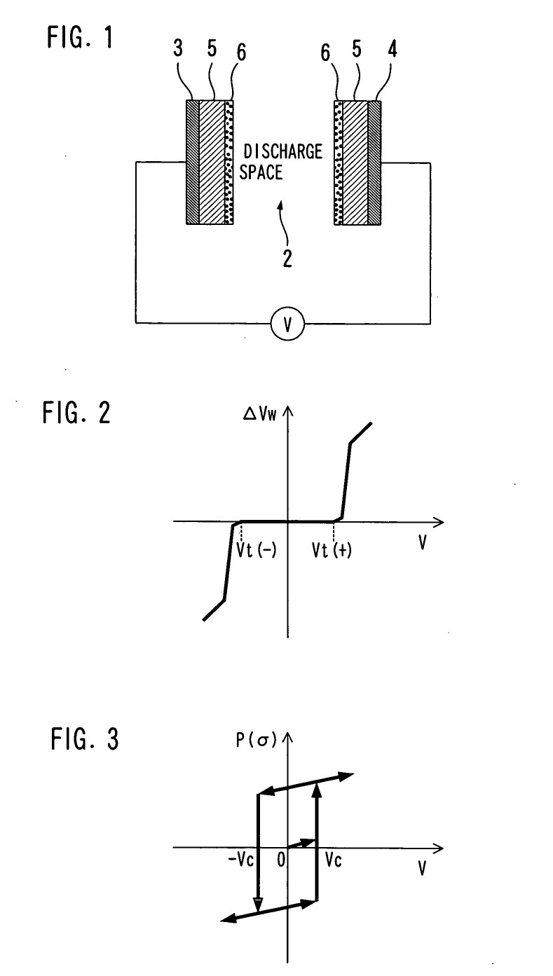

### DESCRIPTION OF THE PREFERRED EMBODIMENTS

The invention will now be described in detail with reference to the attached drawings.

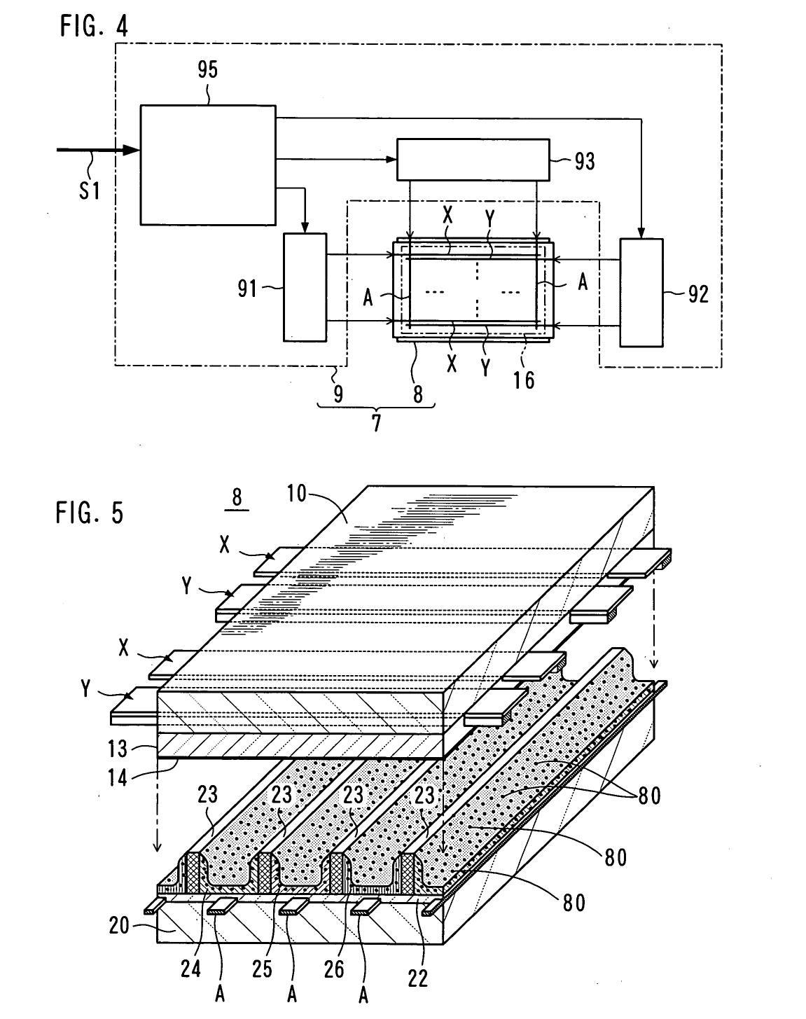

FIG. 4 shows a structure of a display device according to one embodiment of the present invention.

A display device 7 is made up of a three-electrode surface discharge AC type plasma display panel 8 having a screen 16 that is capable of displaying a color image and a driving circuit 9 for driving the plasma display panel 8.

The screen 16 of the plasma display panel 2 is provided with first display electrodes X and second display electrodes Y that are arranged alternately as row electrodes, and it is provided with address electrodes A as column electrodes. The display electrode X and the display electrode Y constitute an electrode pair for generating sustain discharge of surface discharge type on each row of the screen 16. The address electrode A crosses the display electrode X and the display electrode Y in each cell that belongs to the column on which the address electrode A is arranged. Note that each of the display electrode X and the display electrode Y is made up of a thick band-like transparent conductive film and a thin band-like metal film overlapping the transparent conductive film.

The driving circuit 9 includes a driver 91 for applying a drive voltage to the display electrode X, a driver 92 for applying a drive voltage to the display electrode Y, a driver 93 for applying a drive voltage to the address electrode A, and a controller 95 for controlling application of the drive voltages to the plasma display panel 8.

The driving circuit 9 is supplied with a color image signal S1 having a frame rate of 1/30 seconds from a TV tuner, a computer or other image output device. This color image signal S1 is converted into sub frame data by a data processing block of the controller 95 for the plasma display panel 8 to display the image.

The screen 16 of the plasma display panel 8 is a set of cells having a structure shown in FIG. 5. FIG. 5 shows a part made up of six cells corresponding to two rows and three columns within the screen 16. Note that three neighboring cells aligned in the row direction correspond to one pixel of an image.

The first display electrodes X and the second display electrodes Y are arranged on the inner face of a front glass substrate 10. The display electrodes X and the display electrodes Y are covered with a dielectric layer 13, and the surface of the dielectric layer 13 is coated with a magnesia film 14 having spattering-resistant property.

The address electrodes A are arranged on the inner face of a back glass substrate 20, and the address electrodes A are covered with a dielectric layer 22. A plurality of partitions 23 is formed on the dielectric layer 22 for dividing a discharge space. Between neighboring partitions 23, fluorescent materials 24, 25 and 26 are applied, which are excited by ultraviolet rays to emit visible light of red (R), green (G) and blue (B) colors.

The glass substrate 10 and the glass substrate 20 are put together so that the magnesia film 14 and the partition 23 contact each other in reality although they are separated in FIG. 5. A discharge space formed between the substrates is filled with discharge gas that is a mixture of neon and xenon, for example. The discharge gas emits ultraviolet rays for exciting the fluorescent materials 24, 25 and 26 when discharge occurs.

The plasma display panel 8 has a feature that each of the fluorescent materials 24, 25 and 26 contains ferroelectric powder 80. In order to obtain an electron or gas molecule ion emission effect due to polarization inversion, it is preferable that a surface of the ferroelectric is exposed to the discharge gas directly. However, it is possible that the ferroelectric is covered with the fluorescent material as long as electrons can be emitted. Each of the fluorescent material layers 24, 25 and 26 is a porous layer made up of fluorescent material powder having a grain size of approximately from a few microns to 10 microns, while the ferroelectric powder 80 has a grain size that is selected to a value equal to or smaller than the fluorescent material powder. Therefore, most part of the ferroelectric powder 80 is exposed directly to the discharge gas. The higher the mixing ratio of the ferroelectric powder 80 is, the more the parasitic capacitance increases and the luminance decreases. Accordingly, it is preferable that the mixing ratio of the ferroelectric powder 80 is lower than or equal to 10% by weight, more preferably it is within the range from 1% to 1 ppm by weight.

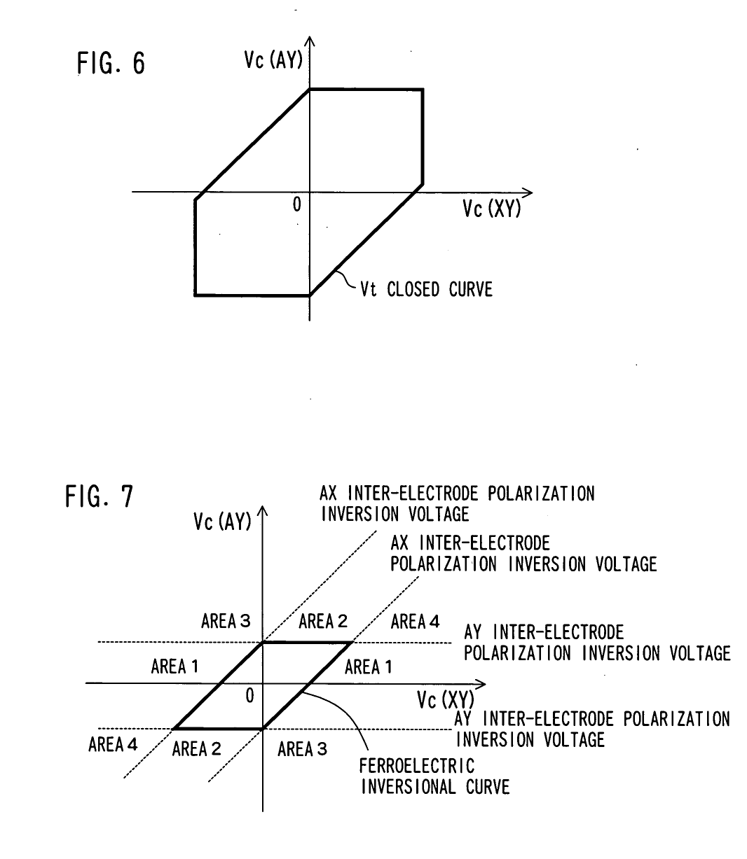

FIG. 6 shows a discharge threshold level closed curve (Vt closed curve) in a cell of a three-electrode structure, and FIG. 7 shows a curve of a potential that generates population inversion of the ferroelectric when the ferroelectric is disposed on the back side of the discharge space (hereinafter referred to as a ferroelectric inversional (inverted) curve for simplicity). The Vt closed curve means a set of points that are threshold voltages (Vt) plotted on a two-dimensional coordinate space (called a cell voltage plane) with the horizontal axis as a cell voltage of a first inter-electrode and the vertical axis as a cell voltage of a second inter-electrode. The threshold voltage (Vt) is a voltage when the discharge starts as the voltage is increased gradually. The Vt closed curve indicates a voltage range where the discharge can be generated. In the illustrated example, the first inter-electrode is an inter-electrode corresponding to the display electrode X and the display electrode Y (an XY inter-electrode), while the second inter-electrode is an inter-electrode corresponding to the address electrode A and the display electrode Y (an AY inter-electrode).

If the ferroelectric is arranged on a back panel, it is sufficient basically to consider the population inversion due to a voltage between the address electrode A and the display electrode X (of an AX inter-electrode) and a voltage of the AY inter-electrode as described above. Therefore, the ferroelectric inversional curve becomes approximately a quadrangle.

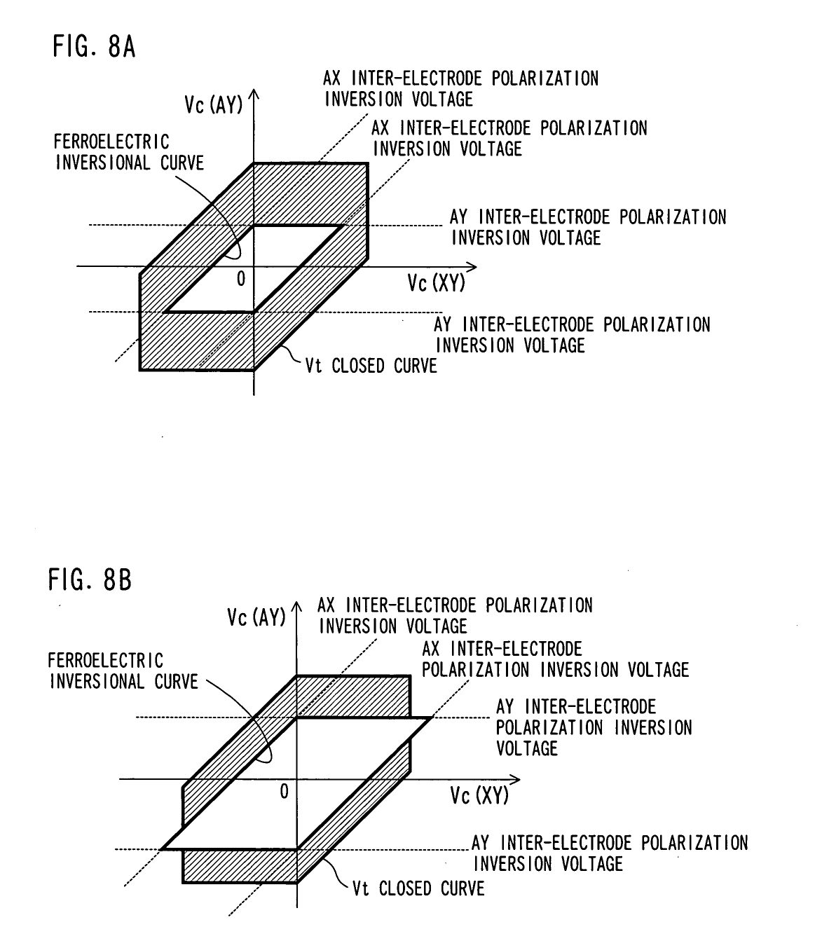

FIGS. 8A and 8B show a relationship between the Vt closed curve shown in FIG. 6 and the ferroelectric inversional curve shown in FIG. 7. As shown in FIGS. 8A and 8B, it is understood through intuition whether or not electrons can be supplied by the polarization inversion of the ferroelectric. It is the most advantageous for driving that the ferroelectric inversional curve is completely included within the Vt closed curve as shown in FIG. 8A. However, even if a part of the ferroelectric inversional curve is located outside the Vt closed curve as shown in FIG. 8B, the polarization inversion can be generated although there is a disadvantage that a voltage control margin is narrow.

Next, an example of a drive sequence including a pulse application step for generating the polarization inversion will be described.

When the plasma display panel 8 displays an image, a sub frame method (also called a sub field method) is used, in which one frame is replaced with a plurality of sub frames. More specifically, in order to reproduce gradation by cells each of which is a binary light emission element, the frame of an input image is divided into a predetermined number of sub frames. Then, each cell within the screen is controlled to emit light in a selected sub frame in accordance with a gradation value to be displayed.

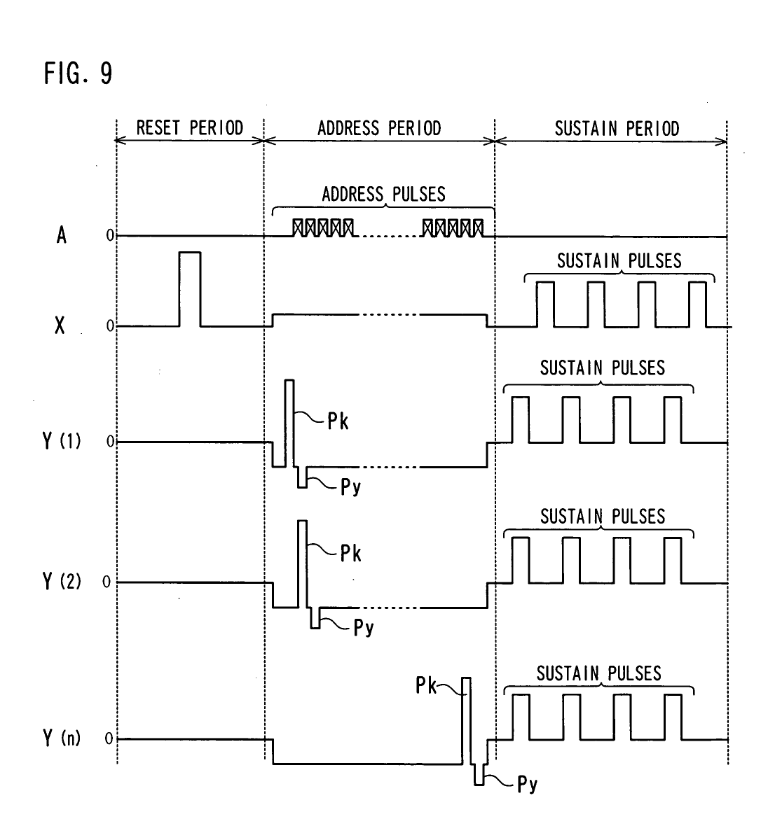

FIG. 9 is a diagram of drive voltage waveforms showing a general drive sequence of a sub frame. In FIG. 9, waveforms concerning the address electrode A and the display electrode X are shown in an overall manner. Concerning the display electrode Y, waveforms of a display electrode Y(1) that is a leading row, a display electrode Y(2) that is a second row and a display electrode Y(n) that is a final row are shown. The illustrated waveforms are merely an example, so the amplitude, the polarity and the timing can be modified variously. The pulse base potential is not limited to the ground potential.

The illustrated waveforms are the most basic ones for the initializing operation to delete wall charge by strong discharge. Also in the case where an obtuse waveform is used for adjusting quantity of wall charge so as to compensate a variation among cells as the initializing operation, only the initializing operation is different while addressing and sustaining are the same as the example, so the following description is true as it is.

Each of the sub frames is assigned with a reset period, an address period and a sustain period. During the reset period, initialization is performed for equalizing wall voltage of all cells within the screen. During the address period, addressing is performed for controlling wall voltage of each cell in accordance with display data. Then, during the sustain period, sustaining is performed for generating display discharge only in cells to be energized. One frame is displayed by repeating the initialization, the addressing and the sustaining.

During the reset period, a positive pulse having sufficiently large amplitude is applied to all the display electrodes X, so that discharge is forced to be generated in all the cells. This discharge causes the wall charge to be formed once again, and a so-called self erasing discharge is generated by the wall charge responding to finish of the pulse application. Most of the wall charge disappears, and a state of the cell at the end of the reset period corresponds to the origin of the cell voltage coordinates space shown in FIG. 8 or its vicinity.

During the address period, all the display electrodes Y are biased to a negative potential while a negative scan pulse Py is applied to one by one of the display electrodes Y sequentially. In other words, a row selection is performed. In synchronization with the row selection, a positive address pulse is applied to the address electrode A corresponding to the cell to be energized on the selected row. The address discharge is generated in the cell selected by the display electrode Y and the address electrode A so that a predetermined wall charge is formed. Then, in this addressing, a pulse Pt having a polarity opposite to the scan pulse Py (the positive polarity in the illustrated example) is applied to each of the display electrodes Y just before the application of the scan pulse Py.

The pulse Pt is applied for reducing the discharge delay of the address discharge after that. The pulse Pt adds an electric field of predetermined intensity to the ferroelectric powder 80 that is mixed to the fluorescent material layer, so that the polarization inversion is generated. The polarization inversion causes generation of the priming particles, and the discharge space becomes a state in which discharge can be generated easily. On this occasion, it is desirable that the application of the pulse Pt does not make the cell voltage exceed the discharge threshold level, i.e., that the pulse Pt does not generate discharge. If the amplitude of the pulse Pt is selected appropriately so that discharge is not generated, undesired change of the wall charge can be prevented, so that the drive condition can be optimized easily.

During the sustain period, a positive sustain pulse is applied to the display electrode Y and the display electrode X alternately. By every application, display discharge is generated between the display electrodes in the cell to be energized. As a variation of the application of the sustain pulse, there is another method in which pulses having different polarities and amplitudes that are a half of the sustain voltage (Vs) are applied to the display electrode Y and the display electrode X at the same time.

Although the example described above has the ferroelectric powder 80 disposed on the back side of the discharge space, it is possible to dispose the ferroelectric powder 80 on the front side of the discharge space. For example, it is possible to distribute the ferroelectric powder 80 on the surface of the magnesia film 14 for protecting the dielectric layer 13 after the magnesia film 14 is formed by vapor deposition. In this case, since the magnesia has a column crystal, it is desirable to use the powder of the grain size that can penetrate between crystals (e.g., nanometer order).

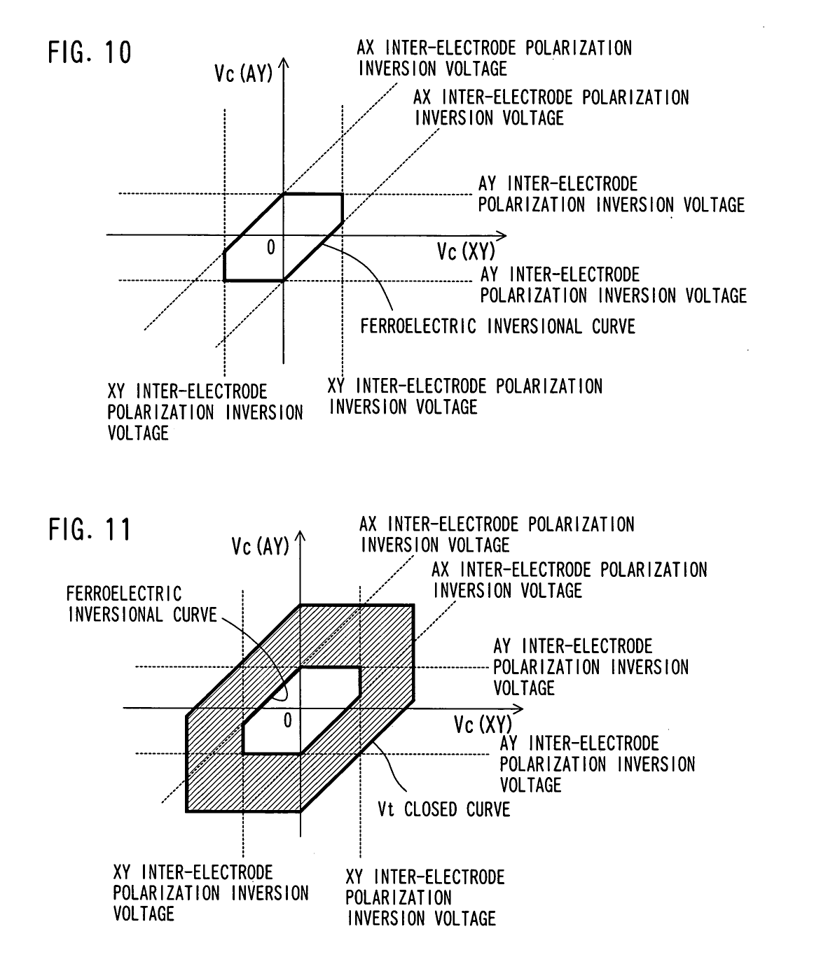

FIG. 10 shows the ferroelectric inversional curve in the structure including a ferroelectric disposed on the front side of the discharge space, and FIG. 11 shows a relationship between the Vt closed curve shown in FIG. 6 and the ferroelectric inversional curve shown in FIG. 10.

If the ferroelectric is disposed on the front side, the ferroelectric inversional curve has a hexagonal shape ideally in the same manner as the Vt closed curve. In this case too, it is advantageous for driving that the ferroelectric inversional curve is completely included in the Vt closed curve as shown in FIG. 11.

Although the case where the polarization inversion is generated during the address period is described in the above embodiment, the present invention is not limited to this case. It is possible to generate the polarization inversion of the ferroelectric powder 80 in the reset period or in the sustain period. Instead of applying the pulse Pt other than the scan pulse Py, it is possible to generate the polarization inversion by the scan pulse Py. It is also possible to generate the polarization inversion by the sustain pulse. It is not always necessary to apply the pulse Pt to every display electrode Y. For example, it is possible to apply the pulse Pt only to the display electrode Y corresponding to the row that is selected in the second half of the address period. It is because the priming particles generated by the initializing operation are almost dispersed in the second half of the address period. In addition, it is possible to apply the pulse so that the display electrode X generates the polarization inversion.

The present invention is useful for stable operation and reduction in a cost of a flat panel display for displaying an image by gas discharge.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A flat panel display comprising a discharge space filled with discharge gas and a plurality of electrodes for generating discharge in the discharge space, wherein
ferroelectric powder is disposed between the electrodes and the discharge space so that the ferroelectric powder contacts the discharge space.

2. The flat panel display according to claim 1, wherein coercive electric field intensity of the ferroelectric is lower than or equal to 50 kV/cm.

3. The flat panel display according to claim 2, further comprising a fluorescent material layer for emitting light due to discharge in the discharge space, wherein the ferroelectric powder is mixed in the fluorescent material layer.

4. The flat panel display according to claim 3, wherein a mixing ratio of the ferroelectric powder is within a range from 0.1 ppm to 10% by weight.

5. The flat panel display according to claim 2, further comprising an insulator layer for covering the electrodes, wherein the ferroelectric powder is mixed in the insulator layer.

6. The flat panel display according to claim 5, wherein a mixing ratio of the ferroelectric powder is within a range from 0.1 ppm to 10% by volume.

7. A plasma display panel comprising:
a pair of first and second substrates facing each other;
a discharge space that is formed between the substrates and filled with discharge gas;
row electrodes arranged on the first substrate;
column electrodes arranged on the second substrate; and
fluorescent material layers that are arranged on the second substrate and emit light due to discharge in the discharge space, wherein
ferroelectric powder having coercive electric field intensity lower than or equal to 10 kV/cm is mixed in the fluorescent material layer at a mixing ratio within a range from 0.1 ppm to 10% by weight.

8. A display device comprising a flat panel display and a driving circuit for driving the flat panel display, wherein
the flat panel display includes a discharge space filled with discharge gas, a plurality of electrodes for generating discharge in the discharge space, and ferroelectric powder disposed between the electrodes and the discharge space, the ferroelectric powder contacting the discharge space, and
the driving circuit generates an electric field for generating polarization inversion of the ferroelectric without generating discharge.

9. The display device according to claim 8, wherein coercive electric field intensity of the ferroelectric is lower than or equal to 50 kV/cm.

10. A display device comprising a plasma display panel and a driving circuit for driving the plasma display panel, wherein
the plasma display panel includes first and second substrates facing each other, a discharge space that is formed between the substrates and filled with discharge gas, first and second row electrodes arranged on the first substrate, an insulator layer for covering the first and the second row electrodes, column electrodes arranged on the second substrate, and fluorescent material layers that are arranged on the second substrate and in which ferroelectric powder having coercive electric field intensity lower than or equal to 10 kV/cm is mixed at a mixing ratio within a range from 0.1 ppm to 10% by weight,
the driving circuit applies sustain pulse to the first and the second row electrodes for generating display discharge during a display period after an address period, and
in the address period, the driving circuit applies a scan pulse for a row selection to each of the second row electrodes and applies an address pulse for a column selection to the column electrode in accordance with display data, and before the application of the scan pulse to each of the second row electrodes, the driving circuit applies a pulse having a polarity opposite to a polarity of the scan pulse for generating polarization inversion of the ferroelectric without generating discharge.
